(19) United States
(12) Patent Application Publication
(10) Pub. No.: US 2018/0290411 A1
(43) Pub. Date: Oct. 11, 2018

(54) ANTI-COLLAPSE COLLAR FOR TIRE CARCASS

(71) Applicant: Compagnie Generale des Etablissements Michelin, Clemont-Ferrand (FR)

(72) Inventor: E Derek FLEMING, Greenville, SC (US)

(21) Appl. No.: 15/763,671

(22) PCT Filed: Sep. 27, 2016
(86) PCT No.: PCT/US2016/053938

§ 371 Date: Mar. 27, 2018

Related U.S. Application Data
(63) Continuation of application No. PCT/US2015/052891, filed on Sep. 29, 2015.

(51) Int. Cl. B29D 30/00

(52) U.S. Cl. CPC B29D 30/0016; B29D 2030/0022

(57) ABSTRACT

An anti-collapse collar is provided that has a body that has an axis. The body has a convex outer surface and defines an interior space. The body has a holding configuration for holding a tire carcass. The body is deformable to a release configuration to move a portion of the outer surface closer to the axis in a radial direction of the body. A release mechanism is spaced from the convex outer surface in the radial direction of the body. Force applied to the release mechanism causes the body to deform to the release configuration.

### FIELD OF THE INVENTION

The present invention relates generally to a collar that prevents a tire carcass from collapsing. More particularly, the present application involves an anti-collapse collar that is used for holding and transportation purposes of a tire carcass that engages a majority of the inner surface of the carcass in a uniform manner.

### BACKGROUND

Tires are manufactured from a variety of components that are wound and built up upon a tire building drum. Thin sheets of rubber and other materials are first wrapped around the tire building drum in layers to form an inner liner, body plies, and sidewalls of the tire. These sections may all be spliced together. Beads, which are high strength steel wires encased in a rubber compound, are then placed onto the wound layers and encased therein by turning the layers up and over the beads. The tire is referred to as a carcass at this stage of the tire building process.

The assembled carcass is then transported to a finishing stage for subsequent processing. At the finishing stage, a summit cap that includes steel belts and tread is attached to the carcass. This attachment can be through the use of splicing, and a TS ring may be used to attach the summit cap to the carcass in some circumstances. After attachment of the summit cap to the carcass, the resulting tire is referred to as a green tire. The green tire is then subsequently cured in a mold under heat and pressure in order to give the tire its final shape. As such, a green tire is one that has not yet been cured. After curing, there may remain some final finishing steps such as inspection of the tire for blisters or blemishes, or measurement of tire balance.

Once the carcass is formed it is placed onto a small cylindrical rod for both storage and transport to the finishing stage in which the summit cap is attached to the carcass as previously discussed. One such cylindrical rod 12 arrangement used to store and transport carcasses is shown in FIG. 1. In order to prevent the carcass 10 from sliding off the cylindrical rod 12, the cylindrical rod 12 may have an upturned terminal end. The diameter of the cylindrical rod 12 is very small compared to the diameter of the carcass 10, and this may cause a uniformity signature to develop in the area of contact between the two as force on the carcass 10 is not uniform during holding and transport by the cylindrical rod 12. As such, there remains room for variation and improvement within the art.

### BRIEF DESCRIPTION OF THE DRAWINGS

A full and enabling disclosure of the present invention, including the best mode thereof, directed to one of ordinary skill in the art, is set forth more particularly in the remainder of the specification, which makes reference to the appended Figs. in which:

FIG. 1 is a perspective view of a prior tire carcass holding device.

FIG. 2 is a perspective view of an anti-collapse collar for a tire carcass.

FIG. 3 is a front view of the anti-collapse collar of FIG. 2.

FIG. 4 is a right side view of the anti-collapse collar of FIG. 2.

FIG. 5 is a bottom view of the anti-collapse collar of FIG. 2.

FIG. 6 is a front view of the anti-collapse collar of FIG. 2 in a holding configuration that holds a tire carcass.

FIG. 7 is a front view of the anti-collapse collar of FIG. 2 in a release configuration in which the tire carcass is released from the collar.

FIG. 8 is a cross-sectional view of the anti-collapse collar of FIG. 2 in which the axial length of the collar extends beyond the bead core of the tire carcass.

FIG. 9 is a cross-sectional view of the anti-collapse collar of FIG. 2 in which the axial length of the collar does not extend to the bead core of the tire carcass.

FIG. 10 is a perspective view of an anti-collapse collar in accordance with an alternative exemplary embodiment.

FIG. 11 is a front view partially in cross-section of the anti-collapse collar of FIG. 10.

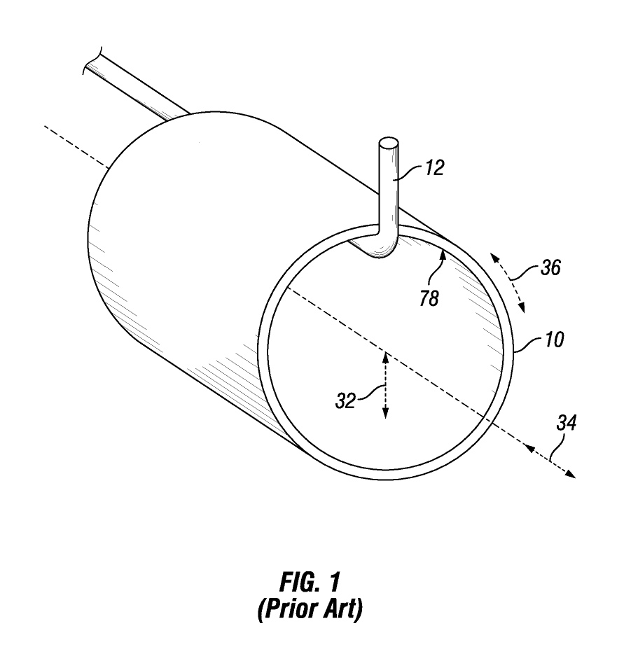

Repeat use of reference characters in the present specification and drawings is intended to represent the same or analogous features or elements of the invention.

### DETAILED DESCRIPTION OF REPRESENTATIVE EMBODIMENTS

Reference will now be made in detail to embodiments of the invention, one or more examples of which are illustrated in the drawings. Each example is provided by way of explanation of the invention, and not meant as a limitation of the invention. For example, features illustrated or described as part of one embodiment can be used with another embodiment to yield still a third embodiment. It is intended that the present invention include these and other modifications and variations.

It is to be understood that the ranges mentioned herein include all ranges located within the prescribed range. As such, all ranges mentioned herein include all sub-ranges included in the mentioned ranges. For instance, a range from 100-200 also includes ranges from 110-150, 170-190, and 153-162. Further, all limits mentioned herein include all other limits included in the mentioned limits. For instance, a limit of up to 7 also includes a limit of up to 5, up to 3, and up to 4.5.

The present invention provides for an anti-collapse collar 14 used to hold and transport a tire carcass 10 in the manufacturing stages before being processed at a finishing stage in which the summit cap is added to the tire carcass 10. The collar 14 has a holding configuration 26 in which a concave outer surface 20 engages the inner surface 78 of the tire carcass 10 and exerts force onto the inner surface 78 to retain the tire carcass 10 onto the concave outer surface 20. The outer surface 20 exerts a force around a majority of the surface area of the inner surface 78 to function not only to securely retain the tire carcass 10, but also to prevent too much force from being imparted onto a small area of the inner surface 78 to prevent stress or uniformity signatures from developing that could impact the performance and build of the resulting tire.

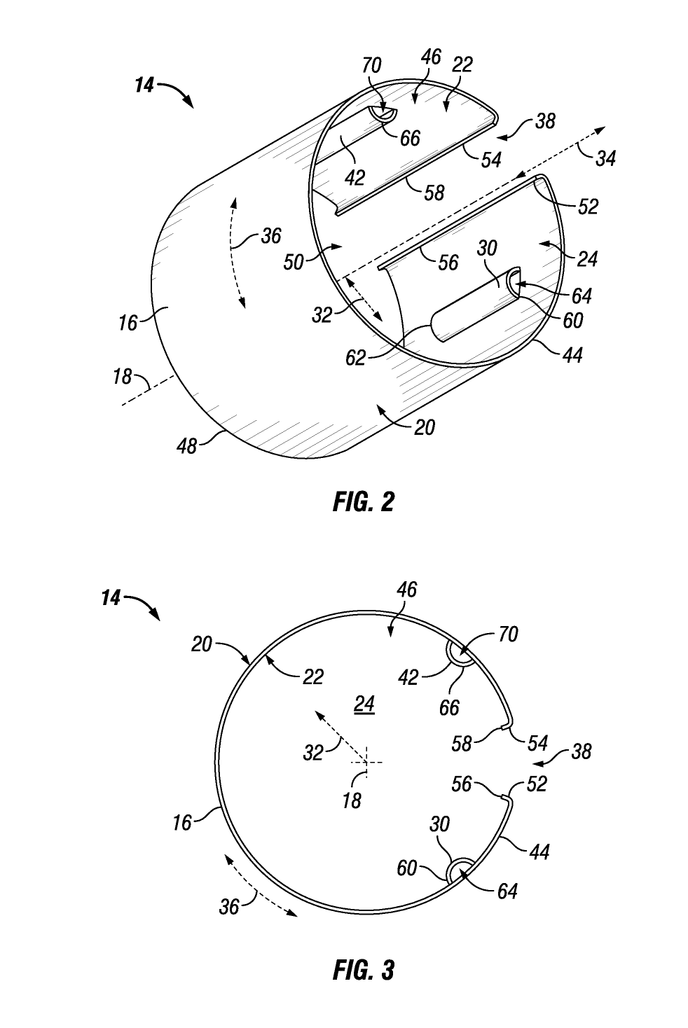

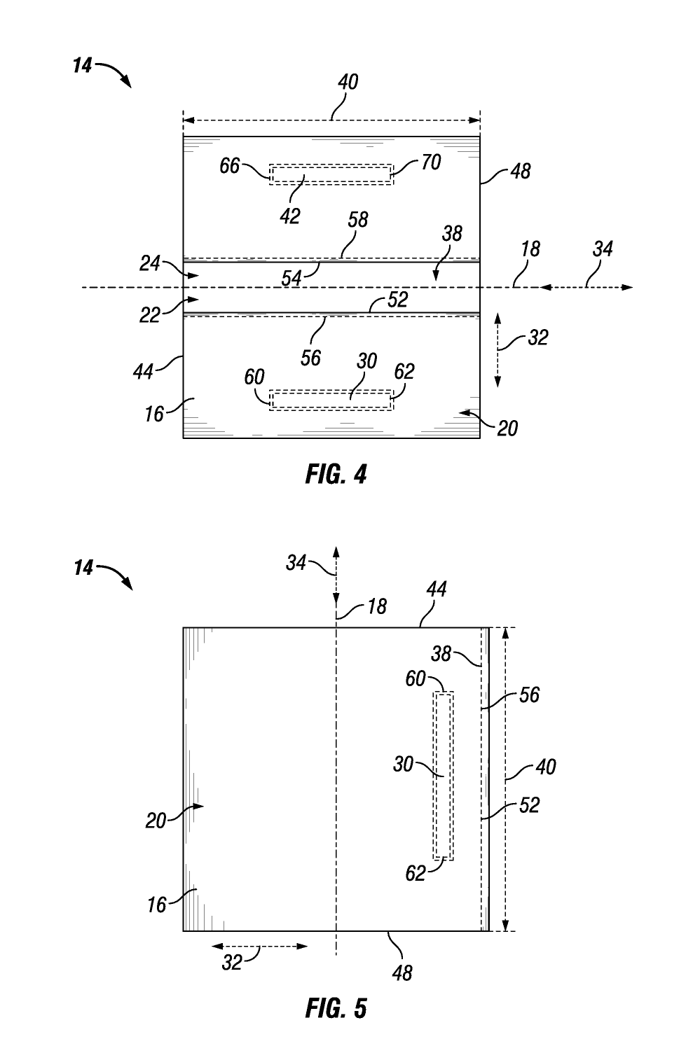

With reference to FIGS. 2-5 an exemplary embodiment of the anti-collapse collar 14 is disclosed. The collar 14 has a body 16 that is cylindrical in shape with an interior space 24 that may extend all the way through the body 16 in the axial direction 34. The interior space 24 is defined by a concave inner surface 22 of the body 16, and may be additionally defined by other features of the collar 14 such as release mechanisms 30, 42 and in-turned flanges 56, 58. The convex outer surface 20 may be convex at all locations so that no portion of the body 16 extends radially beyond the convex outer surface 20 in the radial direction 32. The entire convex outer surface 20 may have the same distance from the axis 18 of the body 16 in the radial direction 32 so that a uniform convex outer surface 20 is realized for use in applying a uniform pressure to the inside of the tire carcass 10 in order to hold the tire carcass 10 and prevent any uniformity signature from developing.

The body 16 may have an axial length 40 that is the same as the length of the body 16 in the radial direction 32. Alternatively, the axial length 40 of the body 16 may be greater than or less than the length of the body 16 in the radial direction 32 in other versions of the collar 14. The body 16 extends around the axis 18 in the circumferential direction 36 but does not extend completely 360 degrees about the axis 18. The body 16 may extend from 180-270 degrees, from 270-320 degrees, from 320-340 degrees, or up to 350 degrees about the axis 18 in the circumferential direction 36 in accordance with various exemplary embodiments. The body 16 has a first circumferential end 52 and an oppositely disposed second circumferential end 54. The ends 52 and 54 are spaced from one another some amount in the circumferential direction 36. The spacing of the first and second circumferential ends 52 and 54 causes a radial opening 38 to be formed so that the interior space 24 can be accessed in the radial direction 32. The radial opening 38 may extend along the entire axial length 40 of the body 16 from the first axial end 44 of the body 16 to the second axial end 48 of the body 16 in the axial direction 34. It is to be understood that in accordance with other exemplary embodiments that the circumferential ends 52 and 54 may overlap one another so that no radial opening 38 is formed in the body 16. Further, in yet other exemplary embodiments the radial opening 38, if present, need not extend all the way along the axial length 40 of the body 16 but can extend some amount in the axial direction 34 less than the entire axial length 40.

The body 16 has the first axial end 44 at one terminal end, and an oppositely disposed second axial end 48 at the other terminal end in the axial direction 34. The axial ends 44, 48 may be flat so that the surface normal of the axial ends 44, 48 are parallel to the axis 18. The first axial end 44 has a first axial opening 46 that is contiguous with the interior space 24. The second axial end 48 has a second axial opening 50 that is likewise contiguous with the interior space 24 so that an opening extends completely through the body 16 in the axial direction 34. In other versions of the collar 14, one or both of the axial ends 44, 48 may be closed so that one or both of the axial openings 46, 50 are not present.

The collar 14 also includes a release mechanism 30 that can be used to actuate the body 16 to convert it from a holding configuration 26 to a release configuration 28. The release mechanism 30 may also be used as a handle or other holding device by a bar, human, or other mechanical device to pick up the collar 14 and transport the collar 14 with or without the presence of the held tire carcass 10. The release configuration 28 may be arranged in a variety of manners, and FIGS. 2-5 disclose but a single possible configuration. The release mechanism 30 is located at the concave inner surface 22 and is completely spaced from the convex outer surface 20 in the radial direction 32 so that no portion of the release mechanism 30 is located at the convex outer surface 20. The release mechanism 30 can be integrally formed with the body 16, or may be a separate component from the body 16 and may or may not be formed of the same material as the body 16.

The release mechanism 30 disclosed has a first axial end 60 and a second axial end 62 located at opposite sides of the release mechanism 30 in the axial direction 34. The release mechanism 30 has an inner cavity 64 that extends along the entire axial length of the release mechanism 30. The first and second axial ends 60 and 62 may be open so that the inner cavity 64 extends along the entire axial length of the release mechanism 30 in the axial direction 34. In other arrangements, one of the axial ends 60 or 62 can be closed so that the inner cavity 64 extends along less than the entire axial length of the release mechanism 30 in the axial direction 34. The inner cavity 64 has a semi-circular cross-sectional shape along its entire length in the axial direction 34. The cross-sectional shape of the release mechanism 30 may be different in other arrangements of the collar 14. The release mechanism 30 may be arch shaped and connected at opposite ends in the circumferential direction 36 to the concave inner surface 22. Alternatively, the release mechanism 30 may have a curved piece that connects to the opposite circumferential ends of the arch and is attached to the concave inner surface 22. Although described as having an arch portion and being semi-circular in cross-sectional shape, the release mechanism may be variously configured in accordance with other exemplary embodiments of the collar 14.

The release mechanism 30 is spaced from both the first circumferential end 52 and the second circumferential end 54 of the body 16 in the circumferential direction 36. The release mechanism 30 may be at least 10 degrees, at least 20 degrees, at least 30 degrees, or up to at least 45 degrees from the first circumferential end 52 in the circumferential direction 36 in other versions of the collar 14. The release mechanism 30 is closer to the first circumferential end 52 than the second circumferential end 54 in the circumferential direction 36. In yet other exemplary embodiments, the release mechanism 30 may in fact be located at the first circumferential end 52 or at the second circumferential end 54. The release mechanism 30 is spaced from the first axial end 44 in the axial direction 34. In this regard, the release mechanism 30 is not located at and does not engage the first axial end 44. The release mechanism 30 does not have a length in the axial direction 34 that is the same as the axial length 40 of the body 16. The release mechanism 30 is likewise completely spaced from the second axial end 48 of the body 16 in the axial direction 34. The release mechanism 30 does not engage and is not located at the second axial end 48. The inner cavity 64 extends in the axial direction 34 so as to be parallel to the axis 18.

The collar 14 may also have a second release mechanism 42 that is also located on the concave inner surface 22. The second release mechanism 42 has an open first axial end 66 and an oppositely disposed open second axial end 68 in the axial direction 34. The second release mechanism 42 likewise has an inner cavity 70 that is semi-circular in cross-sectional shape. The second release mechanism 42 is spaced from both the first circumferential end 52 and the second circumferential end 54 in the circumferential direction 36, and is closer to the second circumferential end 54 than the first circumferential end 52 in the circumferential direction 36. The second release mechanism 42 may be configured and shaped in the same way as the first release mechanism 30 as discussed above, and a repeat of this information is not necessary. It is to be understood that the second release mechanism 42 may be configured and arranged in a different manner than the first release mechanism 30 in accordance with certain exemplary embodiments of the anti-collapse collar 14 so that these two mechanisms 30 and 42 are not sized or shaped in the same manner. Further, the second release mechanism 42 need not be present in accordance with other exemplary embodiments.

A first in-turned flange 56 is located at the first circumferential end 52. The body 16 at this point turns inwards toward the axis 18 in the radial direction 32 and extends from the concave inner surface 22 towards the axis 18 in the radial direction 32. The first in-turned flange 56 prevents a sharp ending edge from being present at the first circumferential end 52. This may help prevent a uniformity signature from being formed on the tire carcass 10 at the location of the first circumferential end 52. The second circumferential end 54 may likewise have a second in-turned flange 58 that extends in the radial direction 32 towards the axis 18 from the concave inner surface 22. The second in-turned flange 58 may prevent a sharp end/edge from being present at the second circumferential end 54 to in turn prevent a uniformity signature from forming on the tire carcass 10 at the location against the second circumferential end 54.

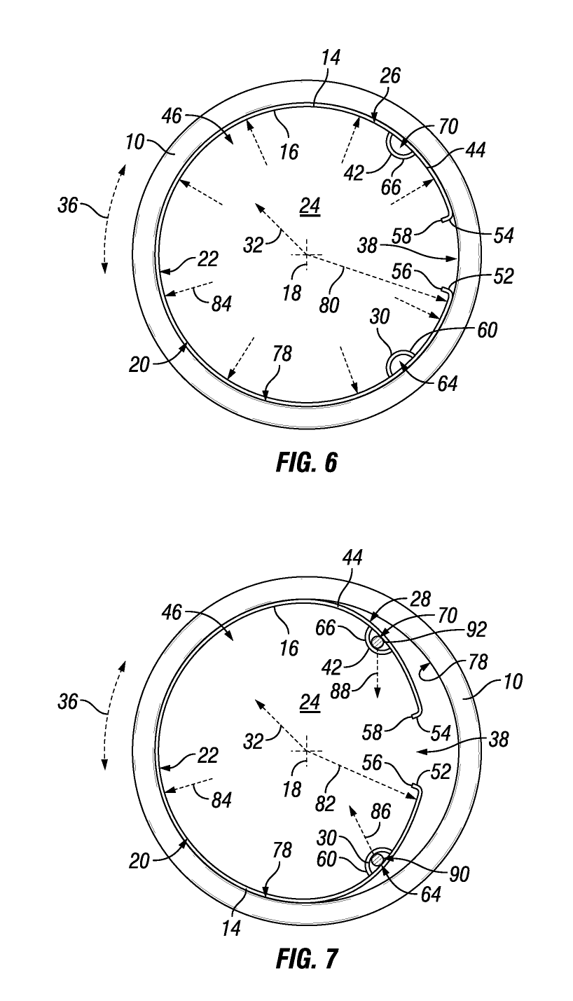

With reference now to FIG. 6, the collar 14 is shown in a holding configuration 26 and is shown holding the tire carcass 10. The body 16 is arranged in a shape that allows it to flex. The material making up the body 16 may also be selected so as to allow it to flex. In some embodiments, the body 16 is made of spring steel, a lighter polymer material, or a plastic comparable to spring steel to allow the body 16 to flex inward and outward in the radial direction 32. The material making up the body 16 and the shape of the body 16 is however strong enough to apply sufficient holding pressure to the tire carcass 10 to both hold the tire carcass 10 and to prevent the tire carcass from collapsing. The body 16 changes shape so as to have the entire convex outer surface 20, or portions of the convex outer surface 20, move closer to or farther from the axis 18 in the axial direction 34.

The body 16 in the holding configuration 26 is compressed in the radial direction 32 so that it is biased inward in the radial direction 32 and wants to expand outward in the radial direction 32. The body 16 therefore exerts a holding force 84 in the radial direction 32 against the inner surface 78 of the tire carcass 10. The holding force 84 is distributed along the convex outer surface 20. This holding force 84 distribution is along the circumferential length of the convex outer surface 20 in the circumferential direction 36, and is along the axial length 40 of the convex outer surface 20 in the axial direction 34. The holding force 84 is applied along the inner surface 78 in both the circumferential direction 36 and the axial direction 34 so that it is evenly distributed along the inner surface 78 and is not concentrated at one portion of the inner surface 78 in the circumferential direction 36 or the axial direction 34. There is no holding force 84 applied against the inner surface 78 at the radial opening 38 because the body 16 is not present at this portion of the anti-collapse collar 14. As such, although the holding force 84 may extend along the entire axial length 40 of the body 16 it does not extend completely 360 degrees about the axis 18 in the circumferential direction 36. The first and second in-turned flanges 56, 58 may help prevent a uniformity signature from forming at the tire carcass 10 proximate to the first and second circumferential ends 52, 54. The distance 80 from the axis 18 to a particular portion of the convex outer surface 20 is illustrated in FIG. 6.

If the tire carcass 10 were not present, and there were no forces exerted onto the first and second release mechanisms 30, 42, the body 16 would expand outward in the radial direction 32 from the position shown in FIG. 6 until it reached an unbiased position which would be its normal, at rest position. As such, the positions of the body 16 shown in FIGS. 6 and 7 are those in which the body 16 is biased by some outside force and is not in an unbiased position.

In order to remove the tire carcass 10 from the anti-collapse collar 14, or to insert the collar 14 into the tire carcass 10 the holding force 84 is removed and the body 16 is moved into a release configuration 28. The release configuration 28 of the body 16 is illustrated with reference to FIG. 7. A pair of rods or arms 90, 92 may be inserted into the inner cavities 64, 70 of the first and second release mechanisms 30, 42. The rod/arm 90 is located into the inner cavity 64 of the first release mechanism 30, and the rod/arm 92 is located within the inner cavity 70 of the second release mechanism 42. The rods or arms 90, 92 may then move from the tire building station to the finishing station in order to transport the tire carcass 10 held thereon. The rods or arms 90, 92 can then move in such a manner to apply removal forces 86, 88 to the first and second release mechanisms 30, 42. The rods/arms 90, 92 may be attached to a machine (not shown) that can move the rods/arms 90, 92 in various directions and that can transport the rods/arms 90, 92 and accompanying body 16 and carcass 10 to a desired location. Alternatively, the rods/arms 90/92 can be attached to a device that is held by a person who in turn moves the assembly to a desired location or actuates the device manually or mechanically to cause the rods/arms 90/92 to apply the removal forces 86, 88.

The removal forces 86, 88 need not be pointed directly at one another, but are generally directed at one another. The direction of the removal forces 86, 88 may have a component that extends inward in the radial direction 32 towards the axis 18, and a component that extends tangential to the radial direction 32. In other exemplary embodiments, the removal forces 86, 88 may not have a component that extends inward in the radial direction 32.

The application of the removal forces 86, 88 against the release mechanisms 30, 42 is translated into the body 16 to in turn cause the body 16 to compress in the radial direction 32. The distance 82 from the axis 18 to the convex outer surface 20 is directed to the same portion of the convex outer surface 20 designated by distance 80 in FIG. 6. The distance 82 is less than the distance 80 in the radial direction 32. Other portions of the convex outer surface 20 will likewise move inwards in the radial direction 32 when the removal forces 86, 88 are applied. It may be the case that the entire convex outer surface 20 will move inwards in the radial direction 32 when the removal forces 86, 88 are applied, or it may be the case that some but not all of the convex outer surface 20 moves inwards in the radial direction 32 when the removal forces 86, 88 are asserted. Inward movement of the convex outer surface 20 in the radial direction 32 causes the holding force 84 to be removed and allows the tire carcass 10 to be removed from the anti-collapse collar 14 as there is no longer sufficient holding pressure applied against the inner surface 78. When it is desired to hold the tire carcass, the collar 14 can be moved or be maintained in the release configuration 28 and the collar 14 can be inserted into the tire carcass 10. The removal forces 86, 88 may then be removed and the collar 14 will assume the holding configuration 26 in which the holding force 84 is again applied to the tire carcass 10 for holding purposes.

FIG. 8 is a cross-sectional view of the collar 14 and tire carcass 10 in which the tire carcass 10 is held onto the collar 14. The tire carcass 10 has a bead 72 and a bead 74 that are separated from one another in the axial direction 34 by an axial distance 76. The body 16 has an axial length 40 that is the maximum axial length of the collar 14. The axial length 40 extends longer in the axial direction 34 than does the axial distance 76. As such, the convex outer surface 20 extends longer in the axial direction 34 than the distance 76 from bead 72 to bead 74. Still further, the axial length 40 extends the same distance as does the inner surface 78 in the axial direction 34 so that the entire inner surface 78 has the holding force 84 applied thereon.

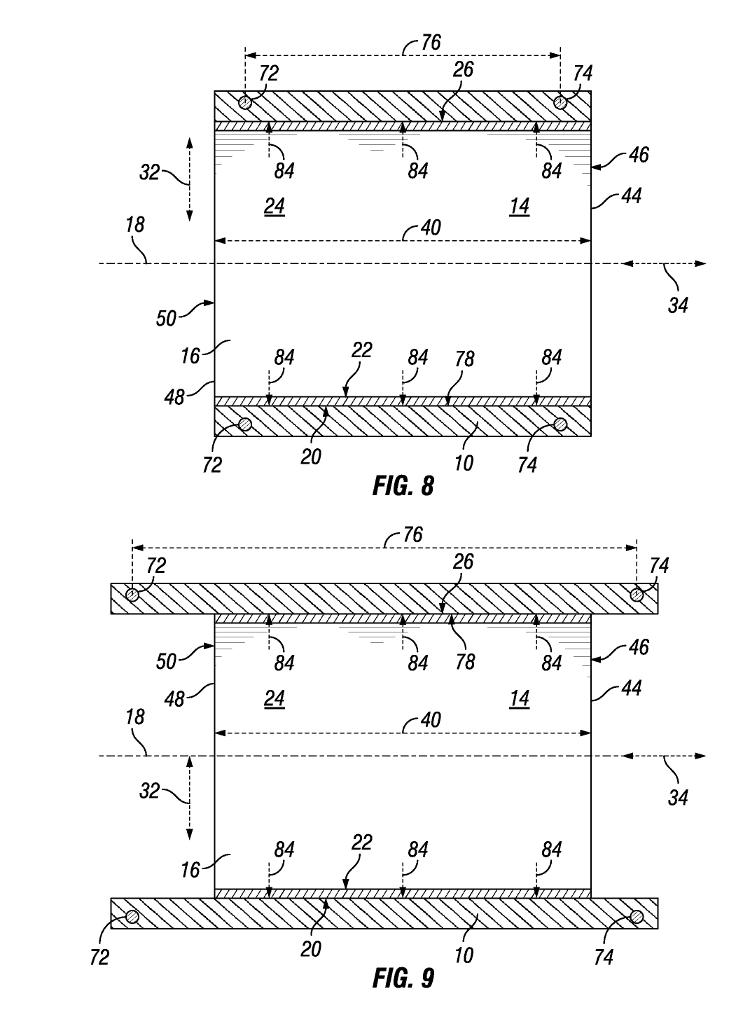

FIG. 9 is a cross-sectional view of the collar 14 and tire carcass 10 in which the axial distance 76 is longer than the axial length 40. In this regard, the holding force 84 is only asserted against a portion of the inner surface 78 and not against all of the inner surface 78. The axial length 40 is between the beads 72, 74 and there is no holding force 84 applied against the beads 72, 74. However, the holding force 84 applied is strong enough to cause the tire carcass 10 to be retained onto the collar 14. In other exemplary embodiments, the axial length 40 can be longer than the axial length of the tire carcass 10.

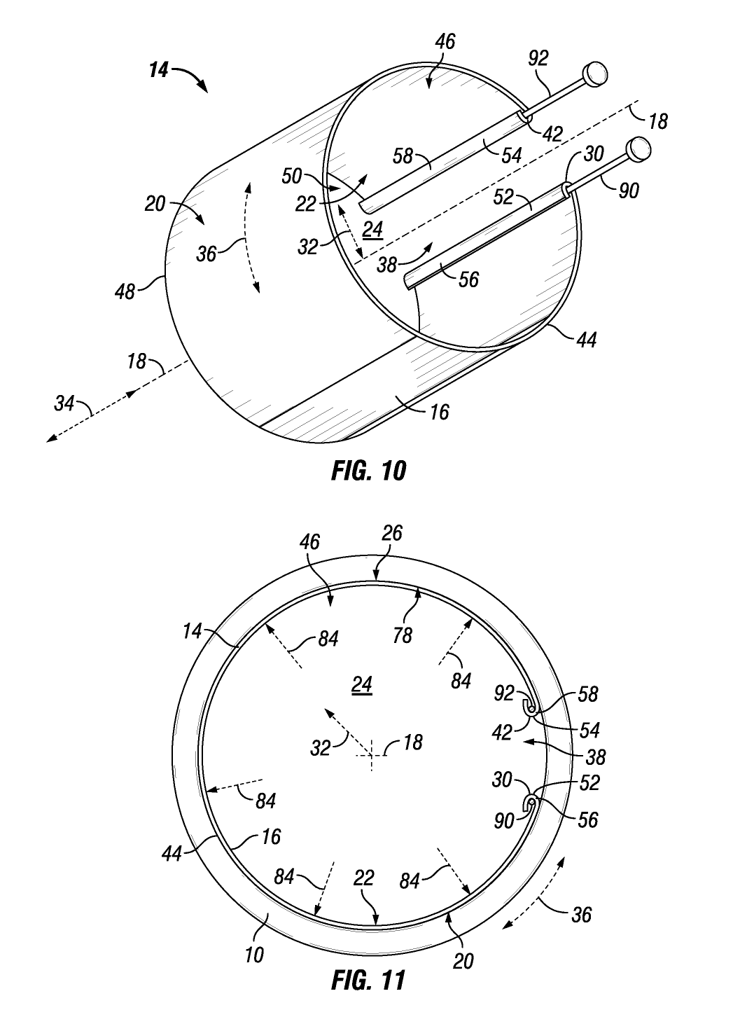

An alternative exemplary embodiment of the anti-collapse collar 14 is shown in FIGS. 10 and 11. The first and second release mechanisms 30, 42 are not arranged in the same manners as previously discussed. Instead, the release mechanisms 30, 42 are located at the first and second circumferential ends 52, 54 and are the first and second in-turned flanges 56, 58. The first in-turned flange 56 extends inward from the concave inner surface 22 in the radial direction 32 and curves backwards and extends in the circumferential direction 36. The first in-turned flange 56 thus forms a hook at the circumferential end 52. The second in-turned flange 58 is arranged in a similar manner as it extends radially inwards from the concave inner surface 22 and then turns back and extends in the circumferential direction 36 so as to form a hook at the second circumferential end 54. The circumferential extension of the first in-turned flange 56 is opposite to the direction of circumferential extension of the second in-turned flange 58.

The rod or arm 90 is inserted into the first in-turned flange 56 and can extend along the entire axial length of the first in-turned flange 56 in the axial direction 34, or may extend less than the entire axial length of the first in-turned flange 56. In a similar manner, the rod or arm 92 is inserted into the second in-turned flange 58 and may extend along the entire axial length of the second in-turned flange 58, or may extend less than the axial length of the second in-turned flange 58. The rods/arms 90, 92 can then be moved in order to move the tire carcass 10 to the finishing station. Further, the rods/arms 90, 92 can be moved in the same manner as previously discussed in order to move a portion or all of the convex outer surface 20 radially inward towards the axis 18 as the first and second in-turned flanges 56, 58 are connected to the body 16. This movement will cause the body 16 to assume the release configuration 28 as previously discussed to allow the tire carcass 10 to be removed from or inserted onto the anti-collapse collar 14. The first and second in-turned flanges 56, 58 are curved inwards in the radial direction 32 in such a manner that they do not form sharp edges or abrupt endings that may cause damage to the tire carcass 10.

Although described as having a pair of removal forces 86, 88 applied to the body 16 in order to compress the body 16 for removal of the tire carcass 10, it is to be understood that only a single removal force 86, 88 need be applied in other exemplary embodiments. For example, the arm 92 may be located at the second release mechanism 42 and may not apply the removal force 88 but may simply remain inserted therein. The arm 90 may apply the removal force 86 to the first release mechanism 30 as previously discussed in order to cause the body 16 to compress. As such, various exemplary embodiments exist in which only a single release mechanism 30 is present, and in which the second release mechanism 42 is not present.

The presence of the anti-collapse collar 14 against the inner surface 78 of the tire carcass 10 prevents collapse of the tire carcass 10 before it reaches and is processed at the finishing station. The body 16 may exert the holding force 84 over a majority of the area of the inner surface 78 of the tire carcass 10 in the holding configuration 26. This area may be from 25%-50% of the area of the inner surface 78, from 50%-75%, from 75%-80%, from 80%-90%, up to 75%, up to 80%, up to 90%, or up to 100% of the area of the inner surface 78. The anti-collapse collar 14 may in some arrangements only be used at times between completion of the tire carcass 10 to the point in processing where the tire carcass 10 reaches the finishing stage in which the summit cap it installed onto the tire carcass 10.

While the present invention has been described in connection with certain preferred embodiments, it is to be understood that the subject matter encompassed by way of the present invention is not to be limited to those specific embodiments. On the contrary, it is intended for the subject matter of the invention to include all alternatives, modifications and equivalents as can be included within the spirit and scope of the following claims.

What is claimed is:

1. An anti-collapse collar, comprising:
a body that has an axis, wherein the body has a convex outer surface, wherein the body defines an interior space, wherein the body has a holding configuration for holding a tire carcass, wherein the body is deformable to a release configuration such that a portion of the outer surface is moved closer to the axis of the body in a radial direction of the body; and
a release mechanism spaced from the convex outer surface in the radial direction of the body, wherein force applied to the release mechanism causes the body to deform to the release configuration.

2. The collar as set forth in claim 1, wherein the body has a concave inner surface, wherein the concave inner surface of the body defines the interior space, wherein the release mechanism is located at the concave inner surface.

3. The collar as set forth in claim 1 or 2, wherein the body extends less than 360 degrees around the axis in a circumferential direction of the body, wherein the body defines a radial opening that extends along an entire axial length of the body.

4. The collar as set forth in any one of claims 1-3, wherein the release mechanism is a first release mechanism, and further comprising a second release mechanism spaced from the convex outer surface in the radial direction of the body, wherein the first release mechanism is spaced from the second release mechanism in a circumferential direction of the body.

5. The collar as set forth in claim 4, wherein force applied to the second release mechanism causes the body to deform to the release configuration.

6. The collar as set forth in any one of claims 1-5, wherein the body defines a first axial opening on a first axial end of the body, and wherein the body defines a second axial opening on a second axial end of the body.

7. The collar as set forth in any one of claims 1-6, wherein the body has a first circumferential end and a second circumferential end, wherein the first circumferential end is spaced from the second circumferential end in the circumferential direction of the body, and further comprising:
a first in-turned flange located at the first circumferential end, wherein the first in-turned flange extends from the body towards the axis in the radial direction; and
a second in-turned flange located at the second circumferential end, wherein the second in-turned flange extends from the body towards the axis in the radial direction.

8. The collar as set forth in claim 7, wherein the first in-turned flange extends in a circumferential direction of the body, and wherein the second in-turned flange extends in the circumferential direction of the body, wherein the release mechanism is the first in-turned flange;
and further comprising a second release mechanism spaced from the convex outer surface in the radial direction of the body, wherein the second in-turned flange is the second release mechanism.

9. The collar as set forth in any one of claims 1-3, wherein the body defines a first axial opening on a first axial end of the body, and wherein the body defines a second axial opening on a second axial end of the body;
wherein the release mechanism is a first release mechanism, and further comprising a second release mechanism spaced from the convex outer surface in the radial direction of the body, wherein the first release mechanism is spaced from the second release mechanism in a circumferential direction of the body;
wherein the first release mechanism and the second release mechanism are spaced from the first axial end of the body in an axial direction of the body, and wherein the first release mechanism and the second release mechanism are spaced from the second axial end of the body in the axial direction of the body.

10. The collar as set forth in claim 9, wherein the body has a first circumferential end and a second circumferential end, wherein the first circumferential end is spaced from the second circumferential end in the circumferential direction of the body;
wherein the first release mechanism is spaced from the first and second circumferential ends in the circumferential direction, and wherein the second release mechanism is spaced from the first and second circumferential ends in the circumferential direction.

11. The collar as set forth in claim 9 or 10, wherein the first release mechanism has a first axial end and a second axial end and is open at both the first axial end and the second axial end of the first release mechanism, wherein the first release mechanism has a first release mechanism inner cavity that is semi-circular in cross-sectional shape;
wherein the second release mechanism has a first axial end and a second axial end and is open at both the first axial end and the second axial end of the second release mechanism, wherein the second release mechanism has a second release mechanism inner cavity that is semi-circular in cross-sectional shape.

12. The collar as set forth in any one of claims 1-7, wherein the release mechanism has a first axial end and a second axial end and is open at the first axial end of the release mechanism, wherein the release mechanism has an inner cavity that is semi-circular in cross-sectional shape.

13. The collar as set forth in claim 4 or 5, wherein the first release mechanism has a first axial end and a second axial end and is open at the first axial end of the first release mechanism, wherein the first release mechanism has a first release mechanism inner cavity that is semi-circular in cross-sectional shape;
wherein the second release mechanism has a first axial end and a second axial end and is open at the first axial end of the second release mechanism, wherein the second release mechanism has a second release mechanism inner cavity that is semi-circular in cross-sectional shape.

14. The collar as set forth in any one of the preceding claims, wherein the body and the release mechanism are made of spring steel.

15. The collar as set forth in any one of the preceding claims, wherein the tire carcass is held by the body in the holding configuration such that an entire axial length of the body in the axial direction is less than an axial distance between two beads of the tire carcass in the axial direction such that the entire body is between the two beads of the tire carcass in the axial direction.
